(19) United States
(12) Patent Application Publication
(10) Pub. No.: US 2004/0043914 A1
(43) Pub. Date: Mar. 4, 2004

(54) Sustained release antimicrobial composition including a partially halogenated hydantoin and a colorant

(75) Inventors: Andrew James Kaziska, Whitehouse Station, NJ (US); Michael Fred Czuczak, Dayton, NJ (US); Philip Gerdon Sweeny, Hackettstown, NJ (US); Daniel Wayne Lemke, Cokato, MN (US)

Correspondence Address: DARBY & DARBY P.C., 805 Third Avenue, New York, NY, 10022, US

(73) Assignee: LONZA INC.

(21) Appl. No.: 10/449,814

(22) Filed: May 29, 2003

Related U.S. Application Data
(60) Provisional application No. 60/384,579, filed on May 29, 2002.

(51) Int. Cl. C11D 3/48

(52) U.S. Cl. 510/383

(57) ABSTRACT

The present invention is an automatic toilet bowl product which contains a colorant and a sanitizer in a homogenous mixture. The product is provided in tablet form. The ingredients include a partially halogenated hydantoin, a binder, a solubility rate modifier and a colorant. The tablet sanitizes and colors the toilet bowl water for the life of the tablet.

This application claims priority from U.S. Ser. No. 60/384,579, filed May 29, 2002, which is hereby incorporated by reference in its entirety.

### FIELD OF THE INVENTION

The present invention relates to a sustained release antimicrobial composition that includes a partially halogenated hydantoin and a colorant.

### BACKGROUND OF THE INVENTION

Automatic toilet bowl (“ATB”) sanitizer products are commonly used today to clean, deodorize and disinfect toilet water and toilet fixtures. ATB products work automatically by their presence in the toilet tank. These products are typically shaped in the form of a solid block or tablet and are placed by the user in the toilet water reservoir. Upon flushing, the cleaning agents are transferred to the toilet bowl and the fresh water which fills the tank dissolves additional agents from the solid. Solid forms have an advantage over liquid forms because of their ease of packaging and use. The tablets are formulated to dissolve slowly in order to provide a sustained, controlled release of active ingredients over time.

Automatic toilet bowl cleaners are typically one of two formulation types: (a) blocks that deliver halogen, acids or bleaching agents for sanitizing; or (b) blocks that deliver detergent materials, such as surfactants for cleaning the toilet bowl surfaces, and dyes or coloring agents that give an aesthetic color to the water in the toilet bowl. The coloring agents also function as an end-of-tablet life indicator; when the color fades, the consumer is alerted that a new tablet should be added to the toilet tank.

Halogen containing bleaching agents such as halohydantoins have been used for bleaching as well as disinfecting in a variety of applications such as dishwashing compositions, toilet bowl cleaning products, and water treatment applications such as swimming pools, cooling water systems, and spas. Various inorganic halogen-containing bleaching agents are known including sodium hypochlorite, sodium hypobromite, chlorine and bromine gas, and N-chloro and N-bromo compounds (see, for example, U.S. Pat. No. 4,654,424). Commonly used halogenated hydantoins are the dihalogenated hydantions. For example, mixtures of dichlorodimethylhydantoin and dichloromethylethydhydantion are commercially available as Dantochlor (Lonza) and mixtures of 1-bromo-3-chloro-5,5,-dimethylhydantoin and bromochloromethylethylhydantoin are commercially available as Dantobrom (Lonza).

Because of the inherent ability of bleaching agents to destroy colorants, it has been difficult to effectively color a bleaching composition so that the colorant remains stable during storage and is available for effective delivery without being altered or destroyed by the bleaching agent. Due to the strong oxidizing power of halogen-containing agents, it is especially difficult to incorporate chemically sensitive components such as a colorants in halogen agent containing ATB products.

Attempts to combine bleaching sanitizers and cleansing agents containing colorants in a product. A bleaching block and detergent block separately pacakged prevent the blocks from coming into contact with each other while in the same toilet bowl (U.S. Pat. No. 5,755,330 to Siragusa et al.). Watanabe et al. utilize an inert material to encapsulate a fragrance or colorant within a solid disinfectant tablet (U.S. Pat. No. 5,958,852).

However a bleaching agent and a coloring agent have not been successfully combined into an ATB cleaning tablet. Thus, there is a need for a convenient solid antimicrobial and cleansing automatic toilet bowl product containing halogen-releasing agents and a colorant in a homogenous mixture which is stable and long-lasting.

### SUMMARY OF THE INVENTION

The present invention provides a composition that includes a partially halogenated hydantoin, a colorant, a binder, and a solubility rate modifier. The composition is preferably in the form of a tablet and is useful as an antimicrobial for the water in a water reservoir, such as a toilet bowl, while imparting a color to the toilet bowl water. The tablet may be a single layer (homogenous mixture) or may also be in the form of a multilayer tablet.

According to the invention, the partially halogenated hydantoin is preferably monochlorodimethylhydantoin (MCDMH). The colorant may be a dye or pigment which enhances the consumer appeal of the tablet and serves as an end-of-life signal for the tablet. Preferred dyes or colorants include Pigment Green 7 and Cu(II) phthalocyanine tetrasulfonic acid, tetrasodium salt. The binder maintains the physical integrity of the tablet and the solubility rate modifier slows the dissolution rate of the tablet. Both the binder and solubility rate modifier contribute to the longevity in usage of the composition.

Applicants have found that by using MCDMH in the antimicrobial composition, the colorant has color stability in the dry composition, i.e., no significant discoloration upon storage. Further Applicants have found that by using MCDMH, the colorant has color stability in solution, i.e., no significant bleaching of the colorant in the water reservoir. Another advantage of the present invention is that the colorant does not adversely affect antimicrobial efficacy of the sanitizing agents. In addition, the Applicants have found that the colorant colors the water for as long as the antimicrobial agent maintains efficacy.

### DETAILED DESCRIPTION OF THE INVENTION

In a preferred embodiment, the amounts of the components of the tablet of the present invention, shown as weight % based on 100% total weight of the tablet, are provided in Table 1 below.

TABLE 1

| | | Broad wt. | Preferred wt. |
|---|---|---|---|
| Component | Function | % Range | % Range |
| Partially halogenated | Biocide | 60-80 | 70 |
| hydantoin | | | |
| Colorant | Aesthetic Appeal/End- | 5-15 | 10 |
| | of-life indicator | | |
| Binder/Solubility Rate | Maintain physical | 10-30 | 20 |
| Modifier | integrity/slow | | |
| | dissolution | | |

The composition of the present invention comprises a partially halogenated hydantoin. The term “partially halogenated hydantoin” is defined herein as a solution, which may be a liquid, such as an aqueous slurry, or solid, containing halogenated hydantoins and, optionally, non-halogenated hydantoins having a degree of halogenation greater than 0 but less than 2. The degree of halogenation is the average number of halogen atoms associated with each hydantoin molecule in the solution. Generally, a halogenated hydantoin having a degree of halogenation of 0<x<1 is a mixture of (non-halogenated) hydantoin and monohalo hydantoin at a molar ratio of 1−x:x. A halogenated hydantoin having a degree of halogenation of 1<x<2 is generally a mixture of monohalo hydantoin and dihalo hydantoin at a molar ratio of 2−x:x−1. For example, a solution having an average of 1.5 chlorine atoms associated with each hydantoin molecule, i.e., Cl_{1.5} hydantoin, has a degree of halogenation of 1.5. A solution containing Cl_{1.5} hydantoin is a mixture of monochloro hydantoin and dichloro hydantoin at a molar ratio of 1:1. Another example of a partially halogenated hydantoin is Cl_{0.9} hydantoin, which is a mixture of hydantoin and monochloro hydantoin at a molar ratio of 0.1:0.9. The term “solution” as used herein includes, but is not limited to, solids, liquids, and gases.

The partially halogenated hydantoin may be an X₍₂₋ₙ₎ dialkyl hydantoin, where X is chlorine, bromine, iodine, or a combination thereof and 0<n<2. According to a preferred embodiment, n ranges from about 0.5 to about 1.5. According to another preferred embodiment, n ranges from about 0.8 to about 1.2. According to yet another preferred embodiment, n is greater than 0.2 but less than 1. According to yet another preferred embodiment, n is greater than 0.75 but less than 0.95. According to yet another preferred embodiment, n is greater than 1 but less than 2. According to yet another preferred embodiment, n is greater than 1.05 but less than 1.4, 1.2, or 1.1. According to yet another preferred embodiment, n is about 0.9 or 1.1. According to yet another embodiment, n is about 1.

The alkyl moieties of the partially halogenated hydantoin may be the same or different. A suitable hydantoin has the formula

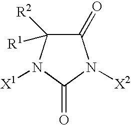

where X¹ and X² are independently hydrogen or halogen and R¹ and R² are independently linear or branched C₁-C₁₀ alkyl. R¹ and R² may be the same or different. R¹ and R² are preferably a C₁-C₄ alkyl.

The partially halogenated hydantoin is preferably X₍₂₋ₙ₎ di-(C₁-C₁₀) alkyl hydantoin, more preferably X₍₂₋ₙ₎ di-(C₁-C₄) alkyl hydantoin, and most preferably X₍₂₋ₙ₎ dimethyl hydantoin or X₍₂₋ₙ₎ methylethyl hydantoin. Preferred partially halogenated hydantoins include, but are not limited to, Cl_{0.5}-5,5-dimethyl hydantoin, Cl_{0.9}-5,5-dimethyl hydantoin, Cl_{1.1}-5,5-dimethyl hydantoin, Cl_{1.05-1.4}-5,5-dimethyl hydantoin, monochloro-5,5-dimethyl hydantoin (MCDMH), Br_{0.9}-5,5-dimethyl hydantoin, monobromo-5,5-dimethyl hydantoin (MBDMH), Cl_{0.5}-5-methyl-5-ethyl hydantoin, Cl_{0.9}-5-methyl-5-ethyl hydantoin, Cl_{1.1}-5-methyl-5-ethyl hydantoin, Cl_{1.05-1.4}-5-methyl-5-ethyl hydantoin, monochloro-5-methyl-5-ethyl hydantoin, Br_{0.9}-5-methyl-5-ethyl hydantoin, monobromo-5-methyl-5-ethyl hydantoin, and any combination of any of the foregoing. Special mention is made of Cl_{0.9}-5,5-dimethyl hydantoin, Cl_{0.9}-5-methyl-5-ethyl hydantoin, Cl_{1.1}-5,5-dimethyl hydantoin, and Cl_{1.1}-5-methyl-5-ethyl hydantoin.

Another suitable partially halogenated hydantoin is ClₐBr_{b}-5,5-dimethyl hydantoin, where a and b independently range from about 0.1 to about 1 and the sum of a and b is less than 1, 1.5, or 2. Preferably, a ranges from about 0.5 to about 1 and b ranges from about 0.1 to about 0.5. A preferred partially halogenated hydantoin of this formula is Cl_{0.75}Br_{0.25}-5,5-dimethyl hydantoin.

The partially halogenated hydantoin is preferably monochloro-5,5-dimethyl hydantoin (MCDMH). MCDMH yields about 43% of its weight in total chlorine upon dissolution.

The composition of the present invention further comprises a colorant. Preferred colorants include, but are not limited to, dyes and pigments. Dyes are soluble in water, while pigments are not. These may include: copper (II) phthalocyanine tetrasulfonic acid, tetrasodium salt, Green 7, Methylene Blue and Methylene Green. In a preferred embodiment, the dye copper (II) phthalocyanine tetrasulfonic acid, tetrasodium salt is used. In another preferred embodiment, the tablet of the invention includes the pigment Green 7, a polychloro copper phthalocyanine. Discoloration usually refers to a loss of color. Color is measured by the amount that is noticeable to the consumer. The colorant is added to the composition in an amount sufficient to deliver color to the bowl water for the entire sanitizing lifetime of the tablet.

To increase or maintain the physical integrity of the partially halogenated hydantoin tablet, especially during handling, the tablet may further comprise a binder or hardener. Preferably the binder is compatible with the active ingredients and facilitates the tableting process. Examples of binders are zinc stearate, stearic acid, ethylene-bis-stearamide, long chain fatty alcohols, sorbitol, and polyethylene glycol.

The tablet may further comprise a solubility rate modifier to decrease the tablet's dissolution rate. Examples of solubility rate modifiers are: zinc stearate, long chain fatty alcohol and Acrawax C.

In a preferred embodiment, one material may serve both as a binder and solubility rate modifier. Examples of materials that serve both as a binder and solubility rate modifier include fatty alcohol (TA1618 from Procter & Gambel, which is a mixture of C₁₆ and C₁₈), stearic acid, zinc stearate, magnesium stearate, and calcium stearate.

The tablet of the invention may also include a surfactant to inhibit staining. A surfactant is preferably present in an amount from about 0% to 90%, more preferably from about 5-15% and most desirably about 10%.

In a further embodiment, the tablet may also contain various additives. Examples of additives which may be added to the present invention, include, for example, fillers, fragrances, lubricants, water softeners, and corrosion inhibitors. Preferably the fragrance ranges form 0-5%, the filler from 0-35%, lubricants from 0-5%, water softeners from 0-20% and corrosion inhibitors from 0-10%.

Although the tablet may comprise a homogenous mixture of ingredients, the composition of the invention may also be formed into a tablet comprising multiple layers. In such tablet, one layer comprises a MCDMH formulation. A second layer comprises a colorant-containing formulation. Preferred colorants include those dyes and pigments previously mentioned. Both the MCDMH formulation and the colorant-containing formulation may also contain such additives as solubility rate modifiers, binders, surfactants, fillers, fragrances, lubricants, water softeners, and corrosion inhibitors. The colorant-containing formulation may contain a similar composition to that of commercial ATB products such as Rain Clean® Blue from Clorox®, 2000 Flushes Blue® from WD-40®, and Blue Plus Fragrance from X-14®. The components of such commercial blue ATB's may be found, for example, in U.S. Pat. No. 4,820,449.

The tablets of the present invention may be prepared by standard tableting processes. The tablets may be formed by blending all ingredients to provide a homogeneous blend and compressing the mixture into tablets. Compression pressure is typically about 5,000 to 15,000 lbs. The tablet may then be further coated with other excipients as required or desired for packaging.

In order to make a two layer tablet, the standard tableting process is also used. The partially halogenated hydantoin and binder are first blended to provide a homogenous mixture and compressed lightly, typically at about 2,500 to 5,000 lbs. The colorant layer is then added on top of the partially halogenated hydantoin/binder layer and is pressed at 10,000 to 20,000 lbs.

The size and hardness of the tablet can be varied depending on the lifetime desired for the tablet. The density of the tablet should be greater than 1 so that the tablet does not float in the toilet tank. The desired shelf life of the tablet is preferably at least one year.

The tablet of the invention is useful for sanitizing a volume of water contained in a water reservoir used in personal care environments such as toilet bowl water, bath tub water and spa water, or in environments where sanitized water is desired to minimize the transmission or infection of bacteria on hard surfaces. The amounts of the active components contained in the tablet provide effective concentrations of the active components when the tablet is dissolved in the volume of the water to be sanitized.

The amounts of the active compounds in the tablet depend upon the size and weight of the tablet. The size of the tablet is determined by the number of weeks for which antimicrobial activity is desired.

The following Examples illustrate more specifically the invention. It will be understood that while the invention as described therein is a specific embodiment thereof, the description above and the example are intended to illustrate and not limit the scope of the invention. Other aspects, advantages and modifications within the scope of the invention will be apparent to those skilled in the art to which the invention pertains.

All patents, patent applications, and other publications cited herein are incorporated by reference in their entireties.

### EXAMPLES

### Example 1

Microbiocidal efficacy experiments were conducted to evaluate the amount of partially halogenated hydantoin required to effectively sanitize a given volume of water. The test determined the amount of total chlorine that was required to provide a reduction in bacteria of at least 99.9%, the EPA approved standard for a “sanitizing” agent. In the test, the bacteria Salmonella choleraesuis (SC) and Enterococcus faecalis (EF) were exposed to two MCDMH-based formulations for 30 minutes. The first formulation (“w/o dye”) contained 80% MCDMH and 20% TA1618 alcohol diluted with water to form the test solution. The second formulation (“with dye”) contained 70% MCDMH, 20% TA1618 and 10% Graphtol Blue also diluted with water to form a test solution. Each sample was challenged with a standard inoculum to achieve no less than 10⁴ colony-forming units per ml (cfu/ml) as a final microbial level. The colonies were counted and the percent reduction in bacteria over the control was calculated.

The data from this experiment are provided in Table 2.

TABLE 2

| | |
|---|---|
| % reduction of SC | % reduction of EF |

| ppm total Cl₂ | w/o dye | with dye | w/o dye | with dye |
|---|---|---|---|---|
| 0.5 | 99.78 | 96.51 | <43 | 78.29 |
| 0.75 | >99.97 | >99.97 | >99.98 | >99.98 |
| 1.0 | >99.97 | >99.97 | >99.98 | >99.98 |

The results of the experiment showed that 0.75 ppm total chlorine from the MCDMH-based formulation was sufficient for sanitizing, i.e., was required to achieve at least 99.9% reduction in bacteria. Halogen levels were measured by a HACH DR/2000 Spectrophotometer and calculated as total chlorine. In addition this test demonstrated that the colorant did not interfere with sanitizing ability.

### Example 2

In order to determine the length of time a concentration of 0.75 ppm total chlorine could be maintained by a tablet according to the present invention, that is, how long the tablet maintained at least 99.9% microbiocidal efficacy, a 50 g tablet including 70% MCDMH (from Lonza), 20% zinc stearate (from Ferro), and 10% Graphtol Green 5869-3 (from Clariant) was placed in a U.S. standard toilet tank using 6 liters of water per flush. The toilet was set to flush automatically every two hours, or twelve times per day. The toilet bowl water was sampled and total chlorine was measured approximately three times per week. The results of the study are shown in Table 3.

TABLE 3

| flush number | ppm total Cl₂ |
|---|---|
| 39 | 9 |
| 85 | 5 |
| 147 | 3.2 |
| 207 | 2.28 |
| 230 | 2.04 |
| 291 | 1.88 |
| 336 | 1.56 |
| 408 | 1.25 |
| 483 | 0.95 |
| 579 | 0.80 |
| 590 | 0.66 |
| 626 | 0.71 |

The results show that at 579 flushes, which corresponds to 6.9 weeks, a sanitizing level (>0.75 ppm) of chlorine was still being delivered by a tablet prepared according to the present invention.

### Example 3

In order to determine the length of time a concentration of 0.75 ppm total chlorine could be maintained by a two layer tablet, that is, how long the tablet maintained at least 99.9% micobiocidal efficacy, a 65 g tablet including a 30 g bleach layer containing 80% MCDMH (from Lonza) and 20% zinc stearate (from Ferro) and a 35 g blue layer containing Clorox® Rain Clean® was placed in a U.S. standard toilet tank using 6 liters of water per flush. The toilet was set to flush automatically every two hours, or twelve times per day. The toilet water was sampled and total chlorine was measured approximately three times per week. The results of the study are shown in Table 4.

TABLE 4

| flush number | ppm total Cl₂ |
|---|---|
| 25 | 7.8 |
| 73 | 4.5 |
| 106 | 3.36 |
| 145 | 2.56 |
| 193 | 2.8 |
| 276 | 1.77 |
| 313 | 2.72 |
| 358 | 3.0 |

The results show that at 358 flushes, which corresponds to 4.3 weeks, the two layered taablet of the invention still delivered a sanitizing level (>0.75 ppm) of chlorine.

What is claimed is:

1. An antimicrobial composition comprising a partially halogenated hydantoin, a colorant, and a binder.

2. The antimicrobial composition of claim 1 in the form of a tablet.

3. The antimicrobial composition of claim 1 wherein the partially halogenated hydantoin is monochlorodimethylhydantoin (MCDMH).

4. The antimicrobial composition of claim 1 further comprising a solubility rate modifier.

5. The antimicrobial composition of claim 1 wherein the binder is selected from the group consisting of long chain fatty alcohols, stearic acid, zinc stearate, magnesium stearate, and calcium stearate.

6. The antimicrobial composition of claim 1 wherein the colorant is a dye.

7. The antimicrobial composition of claim 6 wherein the dye is copper (II) phthalocyanine tetrasulfonic acid, tetrasodium salt.

8. The antimicrobial composition of claim 1 wherein the colorant is a pigment.

9. The antimicrobial composition of claim 1 wherein the colorant is Green 7, Methylene Blue or Methylene Green.

10. The antimicrobial composition of claim 1 comprising about 60 to 90 wt % of the partially halogenated hydantoin, about 10 to 30 wt % of the binder, and about 5 to 15 wt % of a colorant.

11. The antimicrobial composition of claim 10, wherein the partially halogenated hydantoin is present in an amount of about 70 wt %; the binder is present in an amount of about 20 wt %; and the colorant is present in an amount of about 10 wt %.

12. The antimicrobial composition of claim 2 wherein the tablet comprises at least two layers wherein a first layer comprises the partially halogenated hydantoin and binder and wherein a second layer comprises a colorant.

13. The antimicrobial composition of claim 1 wherein the degree of halogenation of the halogenated hydantoin is from about 0.5 to about 1.5.

14. An automatic toilet bowl sanitizer product comprising about 60 to 90 wt % of monochlorodimethylhydantoin, about 10 to 30 wt % of the binder, and about 5 to 15 wt % of a colorant; said product, when used in the toilet bowl reservoir, colors the water for as long as the monochlorodimethylhydantoin maintains is antimicrobial efficacy.

15. The automatic toilet bowl sanitizer product of claim 14 wherein the monochlorodimethylhydantoin remains antimicrobially efficacious so long as the total chlorine concentration in the water is at least 0.75 ppm.
